(19) United States
(12) Patent Application Publication
(10) Pub. No.: US 2025/0129661 A1
(43) Pub. Date: Apr. 24, 2025

(54) SECONDARY WINDOW INSERT

(71) Applicant: R Value, Inc., Portland, OR (US)

(72) Inventors: Timothy James Hartford, Oregon City, OR (US); Samuel Pardue, Portland, OR (US); Craig C. Strong, Portland, OR (US); Jon Neese, Oregon City, OR (US); Mark Pratt, Portland, OR (US)

(21) Appl. No.: 18/924,903

(22) Filed: Oct. 23, 2024

Related U.S. Application Data
(60) Provisional application No. 63/545,341, filed on Oct. 23, 2023.

(51) Int. Cl. E06B 9/02; E06B 9/00

(52) U.S. Cl. CPC E06B 9/02; E06B 2009/005

(57) ABSTRACT

A window insert that includes a rigid first framework having a first end, a rigid second framework having a first end, a first wedge, a second wedge, and an adjustment mechanism. The first end of the second framework extends away from the first end of the first framework. The second framework is substantially perpendicular to the first framework. The first wedge is snugly coupled to the first framework and extends from the first end of the first framework toward the first end of the second framework. The second wedge extends from the first end of the second framework toward the first end of the first framework. An inclined surface of the second wedge is in sliding engagement with an inclined surface of the first wedge. The adjustment mechanism is configured to slide the second wedge relative to the second framework and relative to the inclined surface of the first wedge.

### CROSS-REFERENCES TO RELATED APPLICATIONS

This patent application claims the benefit of Provisional Application No. 63/545,341 filed Oct. 23, 2023, which is incorporated into the present disclosure by this reference.

### TECHNICAL FIELD

The subject matter is related to a system and methods for a window insert to provide a secondary protection to an existing primary window.

### BACKGROUND

Storm windows are generally mounted on the outside or inside of main windows of homes or businesses. They are often used in cold climates to reduce energy leakage from the windows—for instance, cold air leaking into a house through the main windows. Storm windows are generally made from glass, plastic, or other transparent material. In some instances, storm windows may be translucent or opaque.

Many storm window systems are difficult and expensive to install and remove. Existing storm window systems, generally, are mechanically attached with mounting hardware to either the inside or outside of the main window. These windows may be heavy and difficult to manipulate. Interior storm windows do not maintain air tightness in out-of-square window frames because these systems are typically rectangular, and most window frames are out-of-square, which either causes air gaps around the edge or much more cumbersome and expensive installations. Other, less expensive systems use see-through plastic sheets that are taped or attached to window casings. Sometimes the plastic sheets are shrunk to the existing window using a heat gun. When directed at the plastic sheet, the heat gun causes the sheet to contract, making the sheet taut and easier to see through. Such systems are, similar to the mechanical systems described above, difficult and time-consuming to install. The difficulty of installing such existing storm window systems becomes magnified for larger commercial applications, where parts may be even more cumbersome.

Configurations of the disclosed technology address shortcomings in the prior art.

### BRIEF DESCRIPTION OF THE DRAWINGS

FIG. 1 is a first-side isometric view showing a window insert according to configurations, shown installed in a window frame.

FIG. 2 is a first-side, isometric view of the window insert of FIG. 1, shown not installed in a window frame.

FIG. 3 is a second-side, opposite the first side, isometric view of the window insert of FIG. 2.

FIG. 4 is an exploded view of corner components of a window insert, according to configurations.

FIG. 5 is a cross-sectional view of a portion of the window insert, the cross-section being defined in FIG. 2.

FIG. 6 is a cross-sectional view of the portion shown in FIG. 5, further illustrating an auxiliary gasket.

FIG. 7 is a front view of corner components of a window insert, according to configurations.

FIG. 8 is an isometric view of corner components of a window insert, according to alternative configurations.

FIG. 9 is an exploded view of the corner components of FIG. 8.

FIG. 10 is a front view of the corner components of FIG. 8.

FIG. 11 is a cross sectional view of a bracket for joining multiple window inserts, according to configurations.

FIG. 12 is a detail view of the corner of FIG. 4 also showing an example of a rear corner cover, according to configurations.

FIG. 13 is an isometric view showing a window insert according to another example configuration.

FIG. 14 is an exploded view of an example corner of the window insert of FIG. 13.

FIG. 15 is an exploded view of the tension-corner subassembly of FIG. 14.

FIG. 16 is an isometric, sectional view of portions of an example tension-corner core.

FIG. 17 is an isometric view of portions of the tension-corner subassembly of FIG. 14, showing an example engagement between an example first wedge and an example second wedge.

FIG. 18 is a sectional view of portions of an example corner of the window insert of FIG. 13, illustrating an example of a minimum-expansion state.

FIG. 19 is a sectional view of portions of an example corner of the window insert of FIG. 13, illustrating an example of a maximum-expansion state.

FIG. 20 is a front view of a portion of the window insert of FIG. 13, illustrating an example bow for either or both of the frameworks or the cladding legs.

FIG. 21 illustrates an example alternative form of an internal corner, according to configurations.

### DETAILED DESCRIPTION

As described herein, aspects are directed to a window insert for providing secondary protection to an existing primary window. The secondary protection may include, for example, thermal insulation, sound insulation, creating an air and vapor barrier, and blocking or diffusing of light. Configurations of the disclosed technology may provide secondary protection for both commercial and residential windows.

Previously existing technology typically requires the secondary window inserts to be shipped fully assembled, with the glazing fully installed. This can present difficulties with shipping, creating extra expenses and carbon emissions to ship glazing panels to the storm window insert factory, and then to ship the fully assembled window inserts without damaging the frames or the glazing panels. Additionally, fully assembled interior storm windows, or secondary glazing, are difficult and time consuming to move through the interior of existing buildings, which often have furniture or other impediments in front of the existing windows. And, configurations of the technology disclosed here allow for components of the window insert to be shipped separately and assembled upon installation in the existing window.

It is often preferable for performance, aesthetics, and compatibility with window treatments to install interior storm windows inside window frames. Previously existing interior storm window technology is rectangular in shape, which often creates installation and performance problems when mounted inside existing window frames, which are often out-of-square. Configurations of the technology disclosed here allow rectangular pieces of glass to be mounted into a window frame which is out-of-square, while maintaining a tight air-seal between the perimeter of the technology and the existing window frames. A tight air seal is essential for both energy efficiency and acoustic performance, and is very helpful in minimizing the risks of condensation between the primary window and the internal storm window.

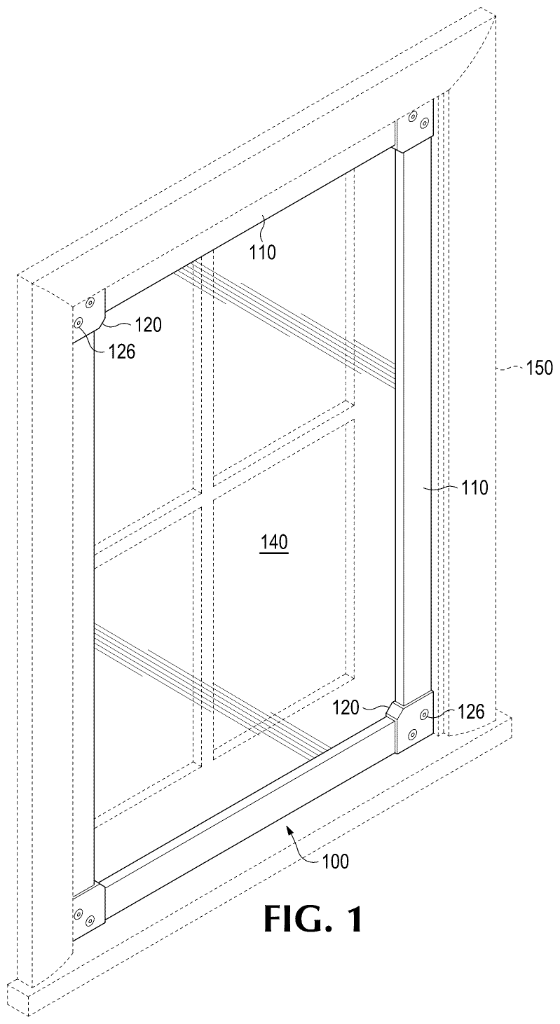

FIG. 1 illustrates a window insert 100, according to configurations, installed in an existing window frame 150. The window insert 100 may include window cladding comprising one or more cladding legs 110 and one or more cladding corners 120, all of which may secure a panel 140 within the window insert 100. As shown, the one or more cladding corners 120 may be secured via one or more corner screws 126, in configurations. Nonetheless, configurations of the disclosure may use alternative hardware or securing means, and still other configurations may have cladding corners 120 with features that secure their position without fasteners. The cladding legs 110 and cladding corners 120 may be made from, for example, extruded metal, such as aluminum, acrylonitrile butadiene styrene (ABS) plastic, or extruded plastic, such as polyvinyl chloride (PVC).

The panel 140 may be made from, for example, glass, polycarbonate, acrylic, medium density fiberboard, film, screen, laminated glass, vacuum insulated glass, insulated glazing units, a laminate layer with no glass, or other materials commonly found in residential and commercial windows.

Although FIG. 1 illustrates a single window insert 100, the window insert 100 may be one of many installed, for example, on a large commercial building or on a residential home. Additionally, although a single pane of the existing window frame 150 is shown, configurations of the window insert 100 may accommodate window frames having more than one pane. As such, configurations of the disclosed technology have wide applicability. As discussed in further detail below, features of the window insert 100 may allow the window insert 100 to accommodate a variety of window sizes and secondary protection needs.

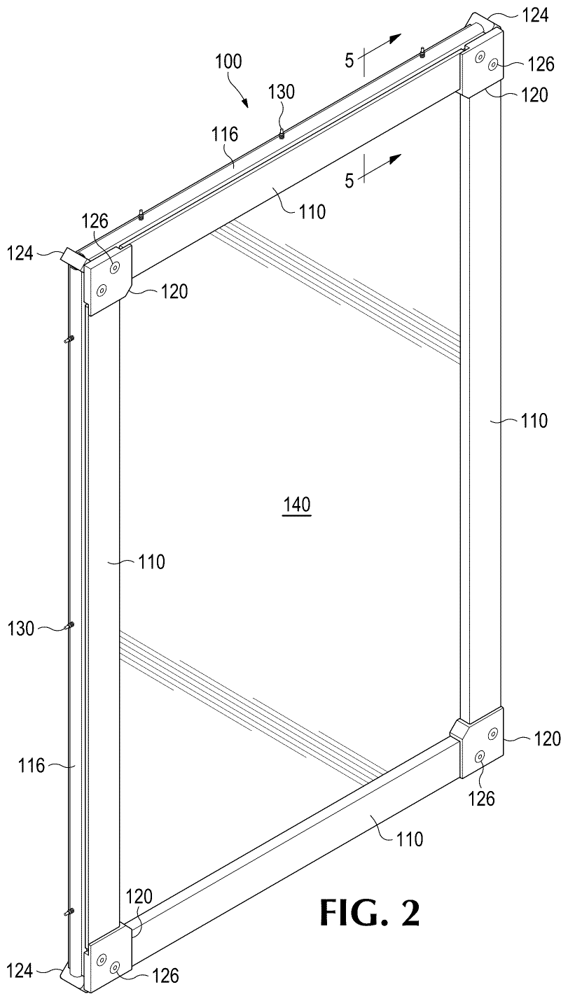

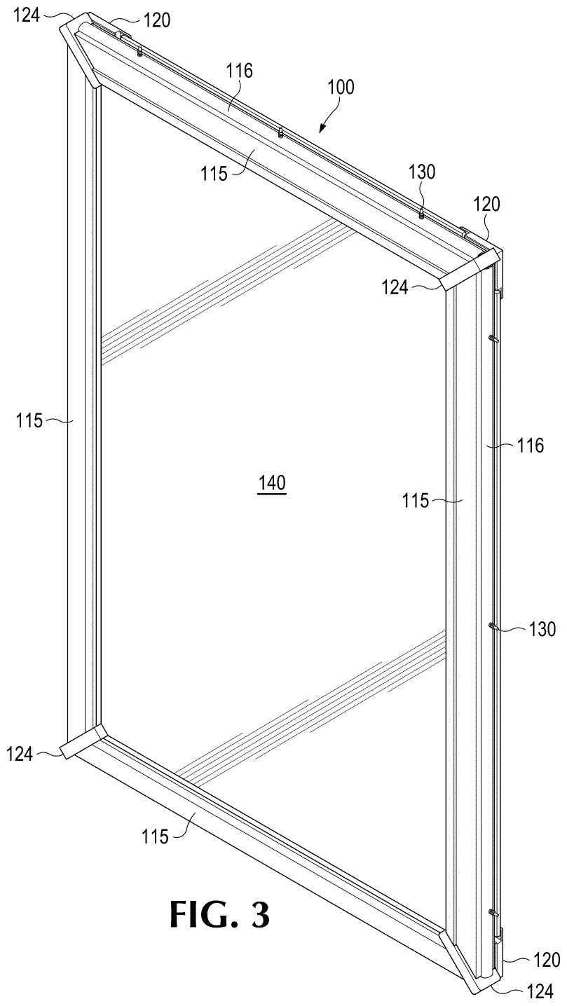

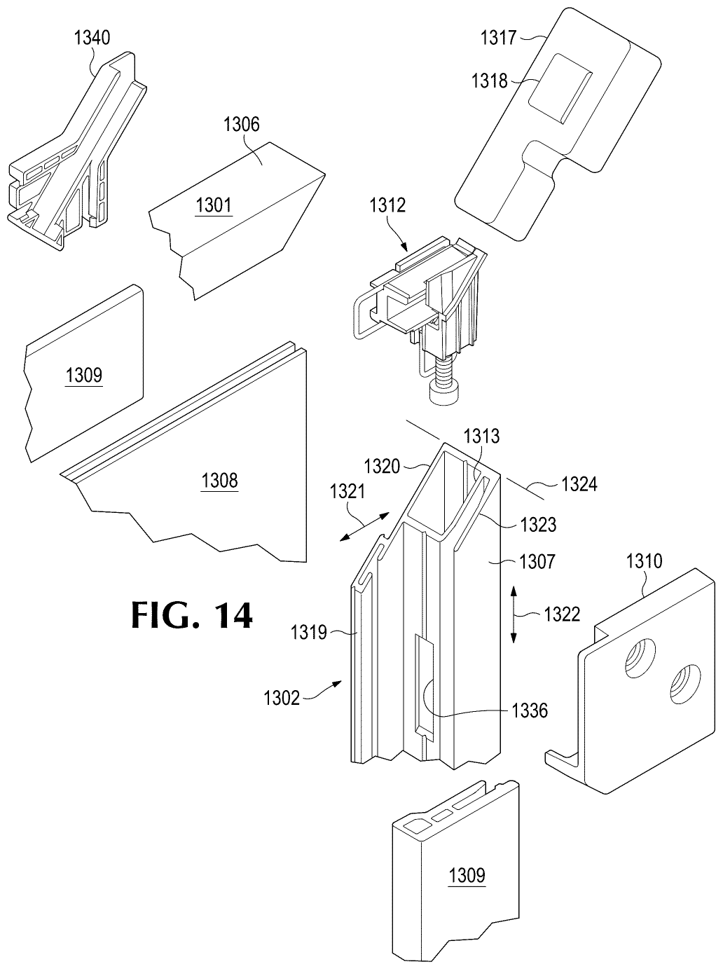

FIGS. 2 and 3 show additional components of the window insert 100 previously discussed. In particular, as best illustrated in FIG. 3, the one or more cladding corners 120 may additionally include one or more foam corners 124 for interfacing with the corners of the existing window frame, not illustrated in FIG. 3. As illustrated, the foam corners 124 are fitted over the internal corners 125 to deflect outward or inward as the window insert 100 matches the out-of-squareness of the existing window frame 150. Additionally, the foam corners 124 can be compressed or decompressed as needed to absorb any out-of-squareness or measurement error. In configurations, the foam corners 124 are made of a closed cell foam, which does not allow air or water vapor to penetrate and also reduces noise transmission. In configurations, the foam corners 124 may have a thickness of about ¾ inch before the foam corner 124 is pinched between the corresponding frame legs 115. In configurations, when assembled, portions of the internal corner 125 pass through the hole (see the hole 1318 in FIG. 14 as an example) in the center of the foam corner 124. Hence, the one or more foam corners 124 may deflect and absorb any out-of-squareness of the existing window frame when the window insert 100 is installed. As such, the window insert 100 may be manufactured so that when installed in the window frame 150, the window insert 100 absorbs window frame irregularities while maintaining a tight seal.

Additionally, the cladding legs 110 and cladding corners 120 shown in FIG. 2 may be installed over an internal frame of the window insert 100. When the cladding legs 110 are installed into the existing window frame 150, they create evenly distributed pressure on the edge of the panel 140 which presses the panel 140 against the panel gasket 417, to create a tight air seal. The internal frame may comprise one or more frame legs 115, four of which are shown in FIG. 3, which may be installed in the existing window frame via mounting screws 130 and may hold the panel 140. Each of the one or more frame legs 115 may also include a perimeter gasket 116 for providing a thermal break and creating an air and vapor barrier between the window insert 100 and the existing window frame. The perimeter gasket 116 may be made from a flexible material—for example, silicone or another resilient elastomer. Similar to the foam corners 124, the flexibility of the perimeter gasket 116 may absorb any irregularities or out-of-squareness of the existing window frame.

To install the window insert 100, the insert is first assembled by mounting the frame legs 115 onto the internal corner 425 onto which is affixed the foam corner 124 Once assembled, the frame legs 115 of the internal frame may be first installed in the window frame via the mounting screws 130, which may initially put pressure on the perimeter gasket 116 of each of the frame legs 115 and press it against an inner surface of the existing window frame. As described in further detail below, the frame legs 115 may first be assembled over internal corners, not illustrated in FIGS. 1-3, to create a complete frame before being installed in the existing window frame via the mounting screws 130. In configurations, an alignment tool may be utilized to guide the frame legs 115 as they are assembled to form the overall internal frame. As a further measure to adapt the window insert 100 to out-of-square window frames, the mounting screws 130 in certain portions of the frame may not be fully tightened, allowing the perimeter gasket 116 to fill a gap between the perimeter of the frame legs 115 and the interior of the window frame 150.

In configurations, the perimeter gasket 116 may have an adhesive base and may be first installed onto each of the frame legs 115 by adhering the perimeter gasket 116 to outer surfaces of the frame legs 115. In other configurations, the perimeter gasket 116 may have a rigid base, each of the frame legs 115 may have a channel for receiving the perimeter gasket 116, and the perimeter gasket 116 may be installed by sliding the rigid base into the receiving channel. FIGS. 2 and 3 show that each of the frame legs 115 may further have three mounting screws 130, but configurations may utilize more or fewer mounting screws 130. Still other configurations may not utilize mounting screws at all. Such configurations may instead rely on the frictional and air-sealed relationship of the perimeter gasket 116 and foam corners 124 with inner surface of the existing window frame. Furthermore, in configurations, the perimeter gasket 116 may have an adhesive strip on its outer perimeter—the surface interfacing with the inner surface of the existing window frame—to facilitate mounting to the window in addition to or instead of hardware.

Once the frame legs 115 are installed inside the window frame, the panel 140 may be installed into the internal frame. Then, the cladding legs 110 and cladding corners 120 may then be installed over the internal frame to compress the panel 140 against the panel gasket 417, and may provide further pressure to seal the perimeter gasket 116 of each of the frame legs 115 against the existing frame. Installing the cladding legs 110 and cladding corners 120, in configurations, may comprise sliding or pressing the cladding legs 110 and cladding corners over the associated frame legs 115, as described in further detail below.

As mentioned, the cladding corners 120 may include corner screws, which may have screw caps 126, shown in FIG. 2, although configurations of the disclosed technology may not utilize screws or other securing means for the cladding corners 120 at all. In configurations including the corner screws 126, however, the corner screws 126 may provide a layer of security for the window insert 100. More specifically, although the cladding corners 120 may be pressed and/or slid onto the frame legs 115 in configurations, the corner screws 126 may prevent the reverse action—i.e., pulling or sliding in the opposite direction—from causing removal of the cladding corners 120 and subsequently the cladding legs 120. In this way, the window insert 100 may be easily installed but may be protected from removal by occupants or trespassers.

Furthermore, the panel 140 of the window insert 100 may be manufactured along with the other components, or it may be separately manufactured. As discussed in further detail below, configurations of the disclosure may accommodate a variety of panel sizes and thus may not require the panel 140 to be manufactured specific to the window insert 100. Rather, the panel 140 may be manufactured from any source. And, because the panel 140 may be separate from the frame components, the window insert 100 does not require pre-assembly before installation. Rather, according to configurations, the window insert 100 may be shipped and/or delivered to an installation site disassembled—for instance, with the cladding legs 110, frame legs 115, cladding corners 120, mounting screws 130, and panel 140 separate from each other.

Additionally, as discussed above with regard to FIG. 3, the internal frame may include foam corners 124 for correcting any out-of-squareness of the existing window frame. As the foam corners 124 deflect to adjust to this out-of-squareness, the foam corners 124 work to adjust the overall shape of the internal frame to coordinate with the existing frame. This deflection at the foam corners 124 further allows for components of the window insert 100 to be shipped and/or delivered disassembled, as the internal frame may be adjust its shape to the existing window frame as it is installed and may nonetheless receive a panel 140. As such, premanufactured panels from outside sources may be received by and supported by configurations of the window insert 100. Crucially, the premanufactured panels can be rectangular, while the interior frame 150 may be out-of-square, and the system will maintain air tightness. The combined action of the flexible corners, the precisely sized interior corners, and the panel gasket enable a tight air seal around the perimeter of the panel 140 where the foam corners 124 and the panel gasket press against the panel 140.

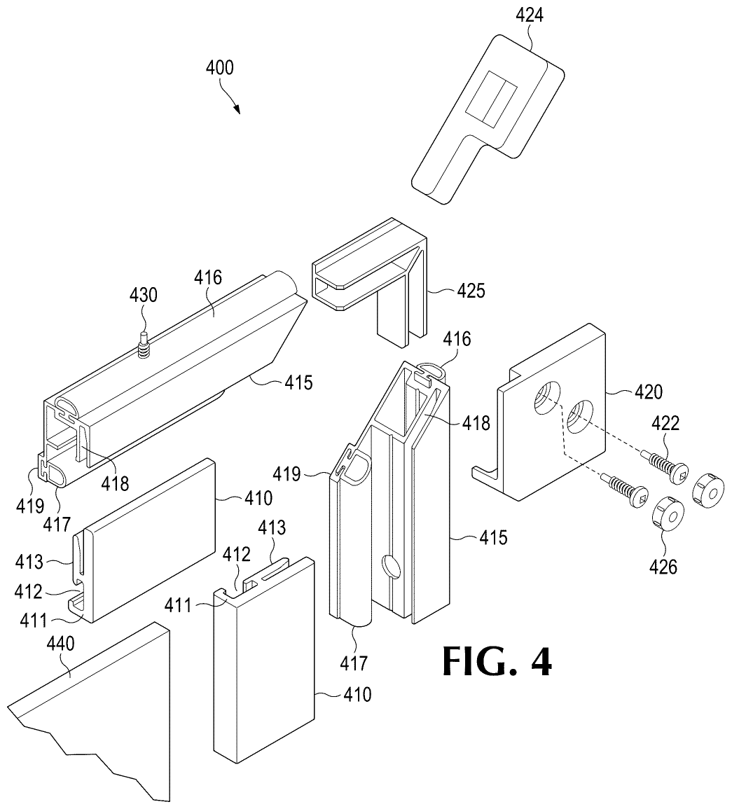

FIG. 4 shows a corner, exploded view of a window insert assembly 400, according to configurations. Similar to the configurations discussed above with regard to FIGS. 1-3, the window insert assembly 400 may include cladding legs 410, one or more frame legs 415 having a perimeter gasket 416, cladding corners 420, foam corners 424, mounting screws 430, and a panel 440. The window insert assembly 400 may also include one or more internal corners 425. The internal corners 425 may be substantially L-shaped, such that a portion of one of the internal corners 425 may fit into and correspond with one of two frame legs 415 meeting at a corner of the window frame. The internal corners 425 may be placed at each corner of the window frame and thus hold together each of two frame legs 415 meeting at each corner. In this way, the internal corners 425 may hold together the internal frame as the internal frame is assembled and then lifted into the existing window frame, and as the mounting screws 430 are secured to the existing frame. As illustrated in FIG. 4, the foam corners may be separate from the internal corners 425. However, in configurations, the foam corners 424 and internal corners 425 may be manufactured as a single unit.

FIG. 21 shows a variation of the internal corner 425 of FIG. 4. The internal corner 2101 of FIG. 21 is similar to the internal corner 425 of FIG. 4 except that it also includes a friction nub 2102 on each of the L-segments of the internal corner 2101. The friction nub 2102 holds the internal corners 2101 inside the frame legs 415 (as is shown for the internal corner 425 of FIG. 4) without requiring the internal corners 2101 to closely match the interior dimensions of the frame legs 415. The internal corners 2101 allow the frame to become out-of-square in order to adjust to angular irregularities in the existing window frame 150. In all places of this disclosure where the internal corner 425 may be used, the internal corner 2101 of FIG. 21 may be used instead.

Returning to FIG. 4, sliding the frame legs 415 onto the internal corners 425, placing the foam corners 424 and perimeter gasket 416 corresponding to each of the frame legs 415 against the existing window frame, and mounting the frame legs 415 to the existing window frame thus forms the basis for the rest of the window insert assembly 400. As mentioned, in configurations, an alignment tool may be utilized to guide the frame legs 415 as they are assembled over the internal corners 425. In particular, the alignment tool may hold the assembled frame legs 415 in proper alignment as the assembly is inserted into the existing window frame, preventing any racking of the frame during installation. Such an alignment tool may hold the assembly only temporarily, and the alignment tool may be removed from the assembly once the frame legs 415 have been secured to the existing window frame. Once the frame legs 415 have been so secured, components of the frame legs 415 may receive the panel 440 and the cladding legs 410 to complete the assembly.

More specifically, each of the frame legs 415 may include a panel gasket 417, a channel 418, and a panel flange 419 to which the panel gasket 417 attaches. Each of the cladding legs 410 may include a panel tab 411, an auxiliary gasket channel 412, and a frame tab 413. Once each of the frame legs 415 are mounted to the existing window frame, the panel 440 may be inserted in the internal frame, and each of the cladding legs 410 may be installed. To install each of the cladding legs 410, the frame tab 413 may slide into the channel 418 of a corresponding frame leg 415, and the panel tab 411 may contact and provide pressure against the panel 440. Putting such pressure against the panel 440 presses it against the panel gasket 417 sitting against the panel flange 419, creating the air and vapor seal and securing the panel 440 over the existing window. Then, the cladding corners 420 may be pressed or slid on to secure the cladding to the internal frame. As shown in FIG. 4 and as previously discussed, in configurations, the cladding corners may include corner screws 422 having screw caps 426, further securing the cladding corners 420 and providing a layer of security to prevent unwanted removal of the window insert assembly 400.

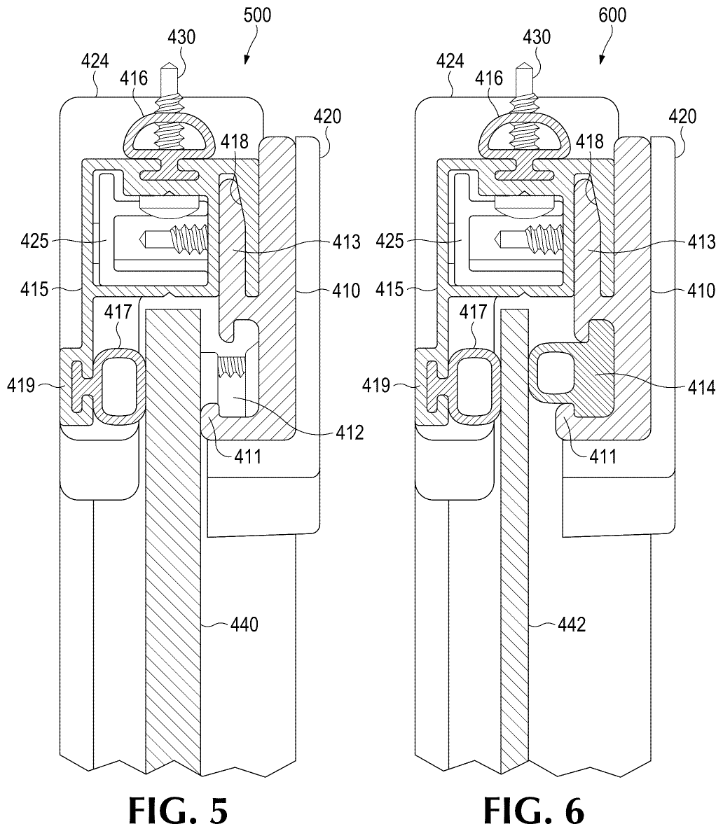

FIG. 5 shows a cross-sectional view of a window insert assembly 500. The cross section is defined in FIG. 2, and the window insert assembly 500 includes many of the same components discussed with regard to the window insert assembly 400 of FIG. 4. As shown, the window insert assembly 500 is fully installed, with mounting screws 430 securing one of the frame legs 415 to the existing window frame and applying pressure against the perimeter gasket 416. Additionally, a panel 440 is placed in the internal frame against the panel gasket 417 sitting against the panel flange 419. One of the cladding legs 410 is installed, with the frame tab 413 fit into the channel 418 of the corresponding internal frame leg. Finally, one of the cladding corners 420 is installed over the frame leg and cladding leg, and thus the cladding leg is providing pressure against the internal frame, panel 440, panel gasket 417 sitting against the panel flange 419, and perimeter gasket 416 to create an air seal between the window insert assembly 500 and the existing window frame.

As shown in FIG. 5, each of the cladding legs 410 may include a panel tab 411 shaped such that it may extend past the frame tab 413 and contact the panel 440, according to configurations. In this way, the panel tab 411 may press against the panel 440 when the frame tab 413 is installed into the channel 418 of the internal frame leg, and the panel 440 may be securely held between the panel tab 411 and the panel gasket 417. In configurations, the size of the panel gasket 417 may be varied to accommodate varying thicknesses of the panel 440. Additionally or alternatively, each of the cladding legs 410 may include an auxiliary gasket channel 412. This auxiliary gasket channel 412 may be shaped such that it may receive an auxiliary gasket to extend beyond the panel tab 411—for instance, when a panel is too thin to be securely held between the panel gasket 417 and the panel tab 411.

Additionally or alternatively, the panel flange 419 may be sized to further absorb any out-of-squareness of the window frame. In configurations, panel flange 419 may be sized to be 0.7″. The size of the panel flange 419 may allow the internal frame of the window insert to receive a rectangular panel 440 despite any out-of-squareness of the existing window. More specifically, as the internal frame may be structured to deflect and accommodate the out-of-squareness of the existing window, the internal frame itself may itself be out of square once installed. The attachment of the panel gasket 417 to the panel flange 419 sized as discussed may then allow further deflection to accommodate the out-of-squareness, allowing a rectangular panel 440 to be received.

FIG. 6 illustrates a cross section of a window insert assembly 600, the cross section being similar to the one just described with regard to FIG. 5 but further including an auxiliary gasket 414. As shown, the auxiliary gasket 414 is shaped such that it may fit into the auxiliary gasket channel 412 of one of the cladding legs 410, and once it is so fitted, it may extend toward the panel gasket 417 past the farthest edge of the panel tab 411. Consequently, a smaller space for accommodating a panel is created between the panel gasket 417 and the auxiliary gasket 414, and a thinner panel 442 may thus be securely held while maintaining an air seal. Additionally or alternatively, in configurations, the size of the panel tab 411 may be varied to accommodate varying panel thicknesses. In still other configurations, a fin may be co-extruded with cladding leg 410 and may extend from the tip of panel tab 411, which may similarly accommodate varying panel thicknesses. As such, configurations of the disclosed technology may accommodate a variety of panel thicknesses, eliminating a need to design and manufacture a panel specific to the disclosed window insert system and instead allowing the disclosed system to be compatible with separately manufactured panels. Additionally, because the auxiliary gasket 414 may be inserted or removed depending on the size of the panel, variations in panel size do not detract from the ability to ship and/or deliver the window insert in a disassembled state.

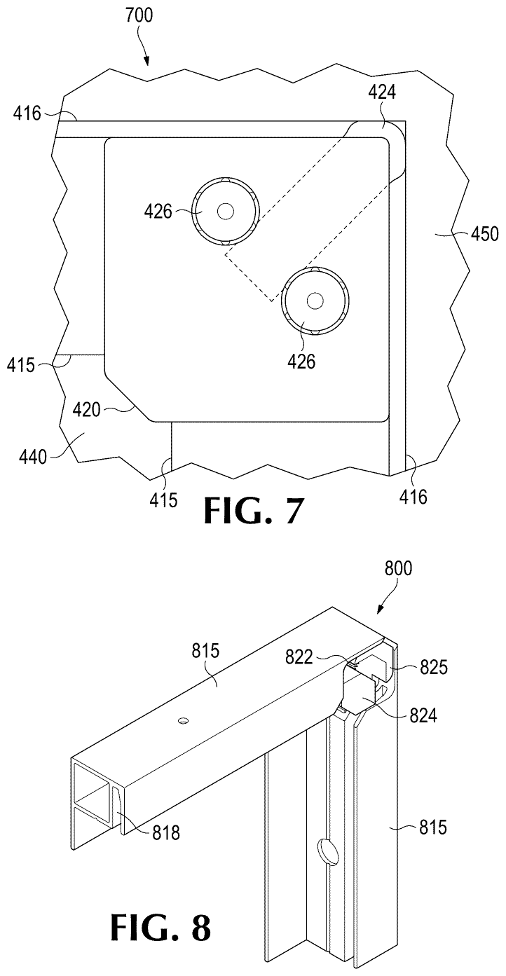

FIG. 7 shows a front, corner view of a window insert assembly 700 having many of the same components discussed with regard to FIG. 4 in a fully installed position. As shown, the installed window insert assembly 700 as viewed from the front may include a one or more cladding legs 415 framing a panel 440 and pressing against the panel 440 such that an air seal is created. Further, the installed window assembly 700 may have one of several cladding corners 420 pressed over the cladding legs 415 meeting at a corner, and screws having screw caps 426 may be used to secure cladding corners 420 and prevent unwanted removal. FIG. 7 also illustrates how foam corners 424 may interact with the corners of the existing window frame 450. For instance, the one of several foam corners 424 depicted in FIG. 7, which may have initially been shaped rectangularly, is deflected from its initial shape where it meets the existing window frame 450. Accordingly, the foam corners 424 may absorb any out-of-squareness of the existing window frame 450 and allow the frame components to adjust to the shape of the existing window frame 450.

In alternative configurations, illustrated in FIG. 8, a window insert assembly 800 may be secured to the existing window frame at the corners. The window insert assembly 800 includes many of the same components described with regard to the configuration illustrated in FIG. 4. For instance, the window insert assembly 800 may include internal frame legs 815 held together with internal corners 825, each of the frame legs 815 having a channel 818 for receiving one or more cladding legs. Although not illustrated in FIG. 8, the cladding legs may take the same form as those described with regard to FIGS. 4-6. The window insert assembly 800 may also include foam blocks 824 and one or more corner screws 822. In configurations such as the one illustrated in FIG. 8, the one or more corner screws 822 may be used to secure the frame legs 815 to the corners of the existing window frame. The corner screws 822 may act on the foam blocks 824 and cause them to deflect based on any out-of-squareness of the existing window frame as the corners screws 822 are secured, and deflection of the foam blocks 824 may cause the internal corners 825 to shift and adjust the frame legs to fit the out-of-squareness.

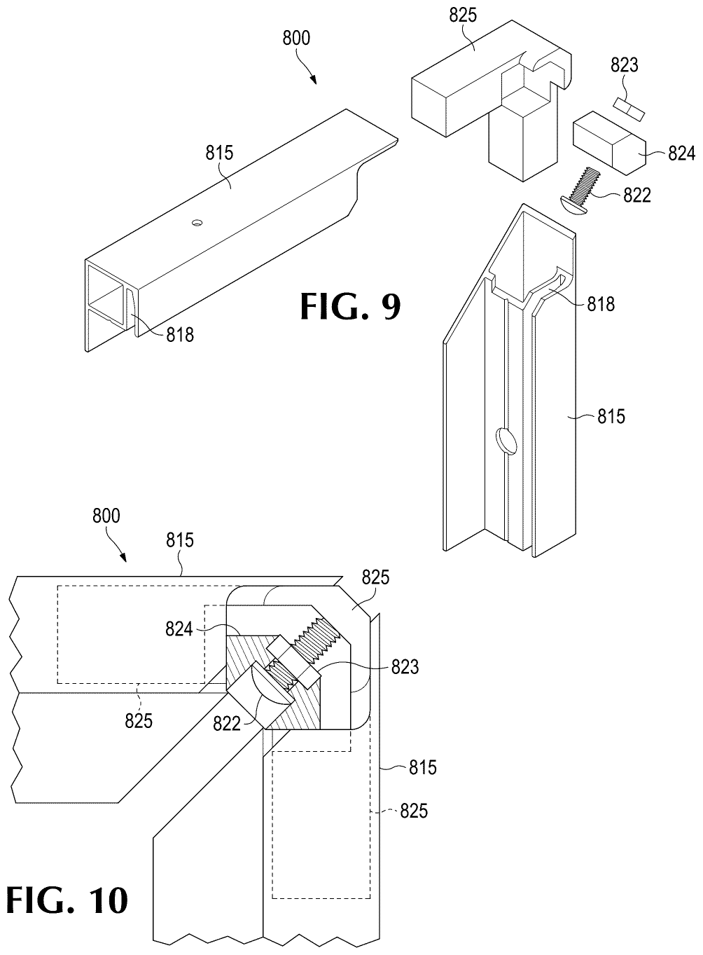

FIGS. 9 and 10 show an exploded isometric view of the window insert assembly 800 and a front view of the window insert assembly 800 in a fully installed position, respectively. As shown in FIG. 9, the one or more corner screws 822 may include one or more bolts 823 to fasten the internal corners 825 to the corners of the existing window frame and act on the foam blocks 824. When fully installed, as shown in FIG. 10, the internal corners 825 may hold together the frame legs 815 in a position dependent on the deflection of the foam blocks 824, allowing the frame legs 815 to fit the shape of the window frame despite any out-of-squareness. In the configurations illustrated in FIGS. 9 and 10, an alignment tool may be utilized to hold the frame legs 815 in proper alignment as they are secured to the existing window frame, preventing any racking of the overall internal frame during installation.

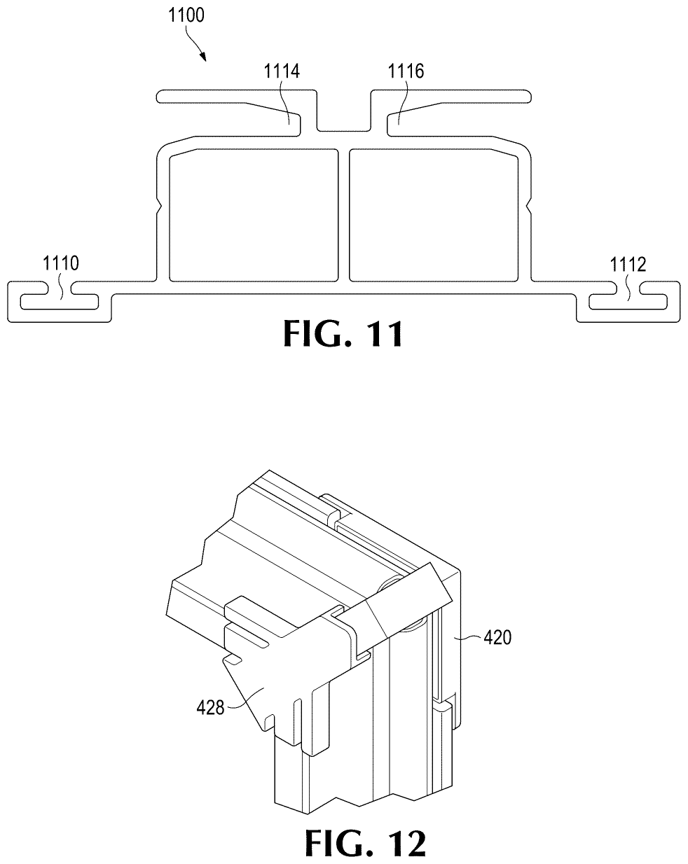

FIG. 11 illustrates a cross sectional view of a bracket 1100, which, in configurations, may be used to subdivide a large existing window frame into multiple, smaller units. The bracket may include gasket channels 1110, 1112 and cladding channels 1114, 1116. The bracket 1100 may be elongated and structured, for example, such that it may replace an internal frame leg on each of multiple frame assemblies, allowing the frame assemblies to meet and be joined together at the bracket 1100. For instance, two frame assemblies, such as those described above with regard to FIGS. 4 and 5, may be joined with bracket 1100. When assembling the first of the two frame assemblies, the bracket 1100 may replace an internal frame leg of the first assembly on a side nearest the second assembly. In this way, the internal frame of the first assembly will comprise three frame legs and the bracket 1100. Similar to the installation described with regard to FIGS. 4 and 5, the window panel may then be installed such that it is received by the primary gaskets of the internal frame legs and a gasket associated with the gasket channel 1110. Then, cladding may be installed over the first internal frame assembly, the cladding leg corresponding to the bracket 1100 being received in the cladding channel 1114.

The same process may then be repeated for the second frame assembly, where the bracket 1100 may replace an internal frame leg of the second frame assembly nearest the first frame assembly, and the panel and cladding may be installed in the second internal frame having three internal frame legs and the bracket 1100. Accordingly, the first and second frame assemblies, once fully installed, are joined at the bracket 1100 with each assembly sharing the bracket 1100 as one of its internal frame legs.

In configurations, the bracket 1100 may be used to join more than two frame assemblies and may further subdivide large existing window frames into smaller units. Subdividing large windows in this way may allow large existing window frames to be secondarily protected without requiring comparably large components to be shipped and assembled. In this way, configurations of the disclosed technology avoid extra expenses and carbon emissions associated with shipping the fully assembled window inserts in situations where very large window frames must be accommodated.

FIG. 12 is a detail view of the corner of FIG. 4 also showing an example of a rear corner cover 428, according to configurations. The rear corner cover 428 may be used to cover the gap between adjacent frame legs 115 on the opposite side of the frame legs 115 than is the cladding corner 420.

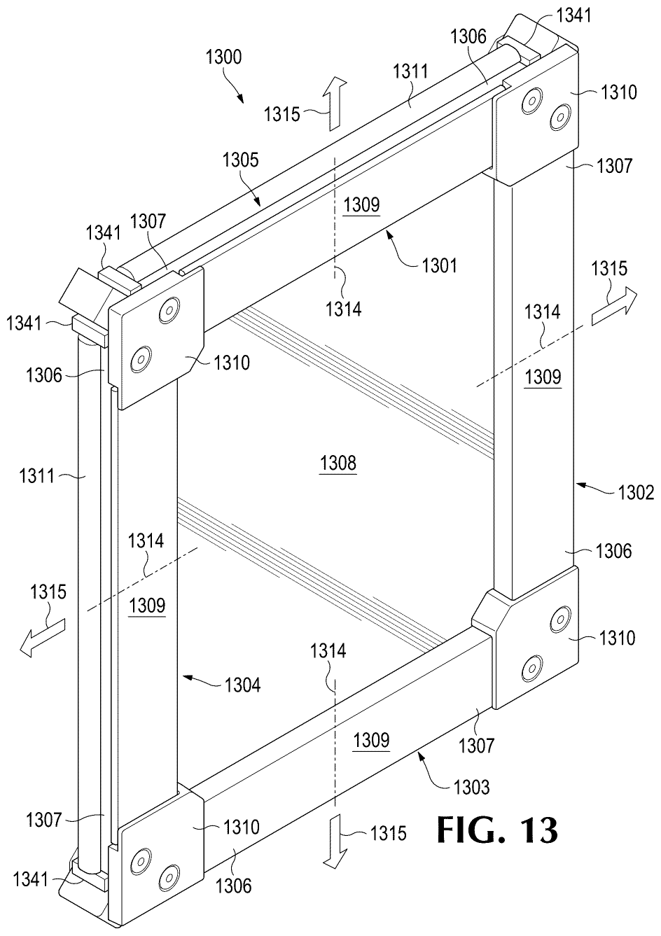

FIGS. 1-12 show a configuration that is typically screwed into the existing window frame 150 with mounting screws, for example, the mounting screws 130 or the mounting screws 430. FIGS. 13-20 illustrate another example configuration, sometimes referred to as a screwless installation because in most circumstances the secondary window frame can be securely installed to the existing window frame 150 without screwing the secondary window frame into the existing window frame 150.

Accordingly, FIG. 13 is an isometric view showing a window insert 1300 according to another example configuration. Like the window insert 100 of FIG. 1, the window insert 1300 of FIG. 13 is intended to installed in an existing window frame 150. As illustrated in FIG. 13, a window insert 1300 may include four substantially rigid, elongated frameworks 1305. As used in this disclosure, “substantially rigid” means largely or essentially stiff and not pliant, without requiring perfect inflexibility. For purpose of discussion, these frameworks 1305 are separately designated a first framework 1301, a second framework 1302, a third framework 1303, and a fourth framework 1304 as labeled in FIG. 13. It is noted that the individual frameworks 1305 are largely hidden behind the cladding legs 1309 in FIG. 13. FIG. 14, however, shows a portion of one of the individual frameworks 1305 (second framework 1302, in this case). The other frameworks 1305 are similar.

Each of the four frameworks 1305 has a first end 1306 and a second end 1307 that is opposite the first end 1306. It is recognized that the designation of which of the two ends of the frameworks 1305 is “first” or “second” is arbitrary and depends on which is being discussed first or second in this disclosure or mentioned first or second in a particular claim. Accordingly, while this Detailed Description section uses the conventions set forth in FIG. 13 for the “first end” and the “second end,” some of the claims might not follow the same conventions because it would be awkward to mention the second end 1307 before mentioning the first end 1306. The same reference numbers and conventions are used to designate the first end and the second end of the cladding legs 1309, too.

As illustrated in FIG. 13, a window insert 1300 also includes a panel 1308; window cladding, including cladding legs 1309 and cladding corners 1310; and perimeter gaskets 1311. The panel 1308 may be made from, for example, glass, polycarbonate, acrylic, medium density fiberboard, film, screen, laminated glass, a laminate layer with no glass, vacuum insulated glass, insulated glazing units, dynamic glass, or other materials commonly found in residential and commercial windows. Hence, in configurations, the panel 1308 is window glazing. The cladding legs 1309 provides a cosmetic finish to the assembled window insert 1300, secure the panel 1308 between the cladding leg 1309 and the glazing flange 1319 and are as described in above for the cladding legs 110 of FIGS. 1-3 and the cladding legs 410 of FIGS. 4-7. The cladding corners 1310 help secure the window insert 1300 once assembled and are as described in above for the cladding corner 120 of FIGS. 1-3 and the cladding corner 420 of FIGS. 4-7. The perimeter gaskets 1311 provide a thermal break and create an air and vapor barrier between the window insert 1300 and the existing window frame 150. They are as described in above for the perimeter gaskets 116 of FIGS. 1-3 and the perimeter gaskets 416 of FIGS. 4-7.

FIG. 14 is an exploded view illustrating aspects of an example corner of the window insert 1300 of FIG. 13. As illustrated in FIG. 14, the window insert 1300 may include the first framework 1301, the second framework 1302, and a tension-corner subassembly 1312. While FIG. 14 illustrates the corner that is between the first framework 1301 and the second framework 1302, the corner as described for FIG. 14 could be any one, two, three, or four of (a) the corner that is between the first framework 1301 and the second framework 1302, (b) the corner that is between the second framework 1302 and the third framework 1303, (c) the corner that is between the third framework 1303 and the fourth framework 1304, and (d) the corner that is between the fourth framework 1304 and the first framework 1301. In configurations, two of the four corners include the tension-corner subassembly 1312, while the other two corners do not, the two corners having the tension-corner subassembly 1312 being kitty-corner from each other.

Using the conventions set forth in FIG. 13, the second end 1307 of the second framework 1302 extends away from the first end 1306 of the first framework 1301. The second framework 1302 is substantially perpendicular to the first framework 1301. As used in this disclosure, “substantially perpendicular” means largely or essentially at right angles, without requiring perfect perpendicularity. Indeed, one of the benefits of the disclosed design is that the window insert 1300 can be installed into an existing window frame 150 that is not perfectly rectangular, while still achieving an equivalent near-airtight seal as when the design is installed into an existing window frame 150 that is perfectly rectangular. Likewise, the second framework 1302 is substantially perpendicular to the third framework 1303, and the second end 1307 of the third framework 1303 extends away from the first end 1306 of the second framework 1302. The third framework 1303 is substantially perpendicular to a fourth framework 1304, and the second end 1307 of the fourth framework 1304 extends away from the first end 1306 of the third framework 1303. The fourth framework 1304 further is substantially perpendicular to the first framework 1301, and the second end 1307 of the first framework 1301 extends away from the first end 1306 of the fourth framework 1304.

In configurations, each framework 1305 has a central column 1313 (FIG. 14). In configurations, the central column 1313 is substantially rectangular in cross section, where the plane of the cross section is substantially perpendicular to the longitudinal direction 1322 of the central column 1313. As used in this disclosure, “substantially rectangular” means largely or essentially shaped like a rectangle or a square. An example of a substantially rectangular central column 1313 is illustrated in FIG. 14.

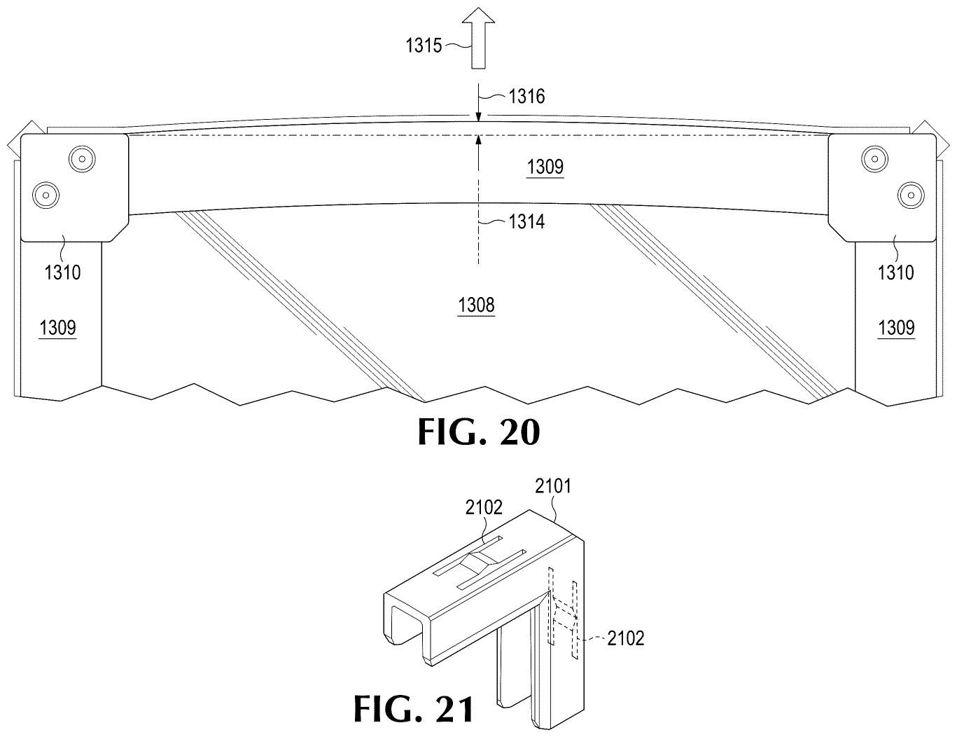

Turning briefly to FIG. 20, FIG. 20 is a front view of a portion of the window insert of FIG. 13, illustrating an example bow for either or both of the frameworks 1305 or the cladding legs 1309. The depiction of the bow is exaggerated for purposes of explanation. In configurations, each framework 1305 has a bow such that the framework 1305 is arcuate from the first end 1306 of the framework 1305 to the second end 1307 of the framework 1305. Stated another way, the framework 1305 bows outward at the midpoint 1314 of the framework, where outward is the direction toward the existing window frame 150, as indication by the arrows 1315 in FIGS. 13 and 20. Preferably, the magnitude 1316 of the bow is between about ⅓ inch and about 1⅔ inch over six feet. More preferably, the magnitude 1316 of the bow is between about ⅔ inch and about 1⅓ inch over six feet. Even more preferably, the magnitude 1316 of the bow is about one inch over six feet. The magnitude 1316 of the bow is the distance between where the top edge at the midpoint 1314 of the framework 1305 would be with the bow and where the top edge at the midpoint 1314 would be if the framework 1305 were straight.

Importantly, the bow of the framework 1305 is present only when the window insert 1300 is not installed into an existing window frame 150. Once installed in the existing window frame 150, the bow of the framework 1305 is no longer present. This is because, during the installation process, the existing window frame 150 pushes back on the bow of the framework (by contacting the midpoint 1314 of the framework, perhaps through the perimeter gasket 1311 when a perimeter gasket is present) while the corners of the window insert 1300 are adjusted. This is explained further below in the discussion on installing the window insert 1300. As a result, once installed, each framework 1305 is essentially straight, or bowless.

In configurations, each cladding leg 1309 has a bow such that the cladding leg 1309 is arcuate from the first end 1306 of the cladding leg 1309 to the second end 1307 of the cladding leg 1309. Stated another way, the cladding leg 1309 bows outward at the midpoint 1314 of the cladding leg 1309, where outward-as noted above-is the direction toward the existing window frame 150, as indication by the arrows 1315 in FIGS. 13 and 20. Preferably, the magnitude 1316 of the bow is between about ½ inch and about 2½ inch over six feet. More preferably, the magnitude 1316 of the bow is between about 1 inch and about 2 inch over six feet. Even more preferably, the magnitude 1316 of the bow is about 1½ inch over six feet. The magnitude 1316 of the bow is the distance between where the top edge of the midpoint 1314 of the cladding leg 1309 would be with the bow and where the top edge of the midpoint 1314 would be if the cladding leg 1309 were straight.

Importantly, the bow of the cladding leg 1309 is present only when the window insert 1300 is not installed into an existing window frame 150. Once installed in a window frame 150, the bow of the cladding leg 1309 is no longer present. This is because, during the installation process, the existing window frame 150 pushes back on the bow of the cladding leg 1309 (by contacting the midpoint 1314 of the cladding leg 1309). This is explained further below in the discussion on installing the window insert 1300. As a result, once installed, each cladding leg 1309 is essentially straight, or bowless. The outward bow of the cladding leg 1309 allows the cladding leg 1309, which is constrained on each end by a cladding corner 1310, to touch the inside edge of the existing window frame 150 substantially across the full length of the cladding leg 1309.

In configurations, neither, either, or both the cladding leg 1309 and the framework 1305 may have a bow as described above.

Returning to FIG. 14, in the illustrated configuration, the window insert 1300 includes a compressible seal 1317 pinched between the first end 1306 of the first framework 1301 and second end 1307 of the second framework 1302. As with the foam corners 124 of FIGS. 1-3 and the foam corners 424 of FIGS. 4-7, the compressible seal 1317 may deflect and absorb any out-of-squareness of the existing window frame 150 when the window insert 1300 is installed. In configurations, a similar compressible seal 1317 is located at each of the four corners of the window insert 1300. In configurations, the compressible seal 1317 is a foam seal. In configurations, the foam seal is made from a closed-cell or a nearly-closed-cell material, such as EnsoLite SFO provided by Armacell Enterprise GmbH & Co. KG. In the illustrated configuration, the compressible seal 1317 is a foam seal having the approximate shape of a lowercase letter “b” to allow the compressible seal 1317 to fit around other components. When assembled, portions of the tension-corner subassembly 1312 pass through the hole 1318 in the center of the “b” shape.

As illustrated in FIG. 14, each framework 1305 may include a glazing flange 1319. As illustrated, the glazing flange 1319 extends away from a first edge 1320 of the central column 1313 in a transverse direction 1321 of the central column 1313. The transverse direction 1321 is substantially perpendicular to a longitudinal direction 1322 of the central column 1313. The glazing flange 1319 is configured to align the panel 1308 to the framework 1305 and position the panel 1308 within the window insert 1300. In configurations, the glazing flange 1319 has a width ranging from 0.4 inch to 1.25 inch, and an ideal width of 0.7 inches to absorb out of squareness from the existing window 150 while maintaining full overlap with the outside edge of the rectangular panel 1308.

Each framework 1305 may also include a cladding flange 1323 that is configured to align the cladding legs 1309 to the frameworks 1305. As illustrated in FIG. 14, a datum 1324 is introduced to explain the positioning of the cladding flange 1323. One side of the central column 1313 coincides with the datum 1324, and the datum 1324 is substantially perpendicular to the transverse direction 1321 of the central column 1313. The cladding flange 1323 extends away from the datum 1324 in the transverse direction 1321 of the central column 1313.

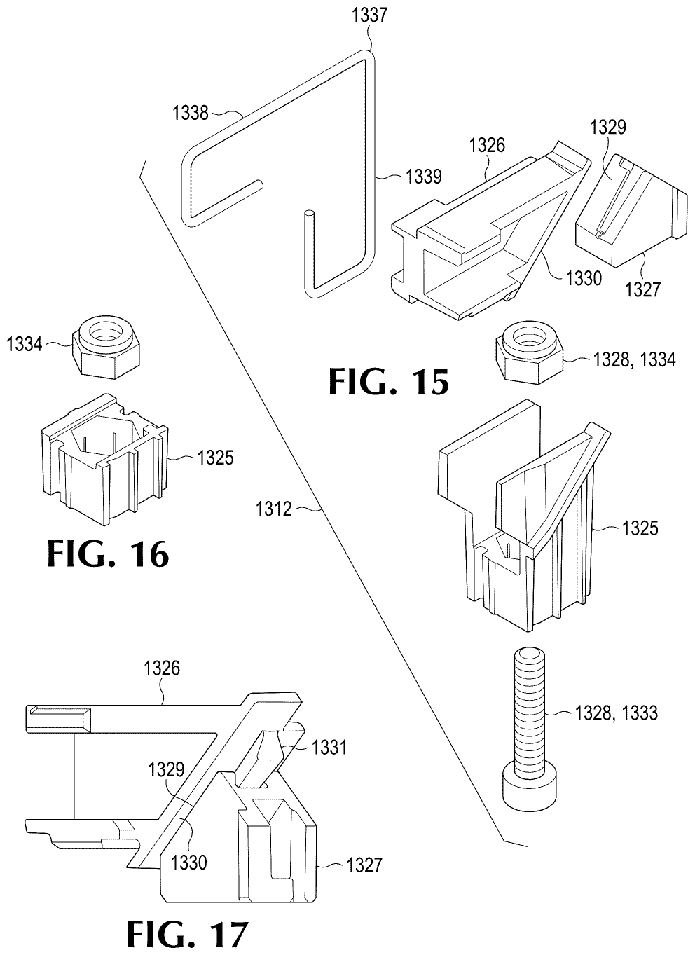

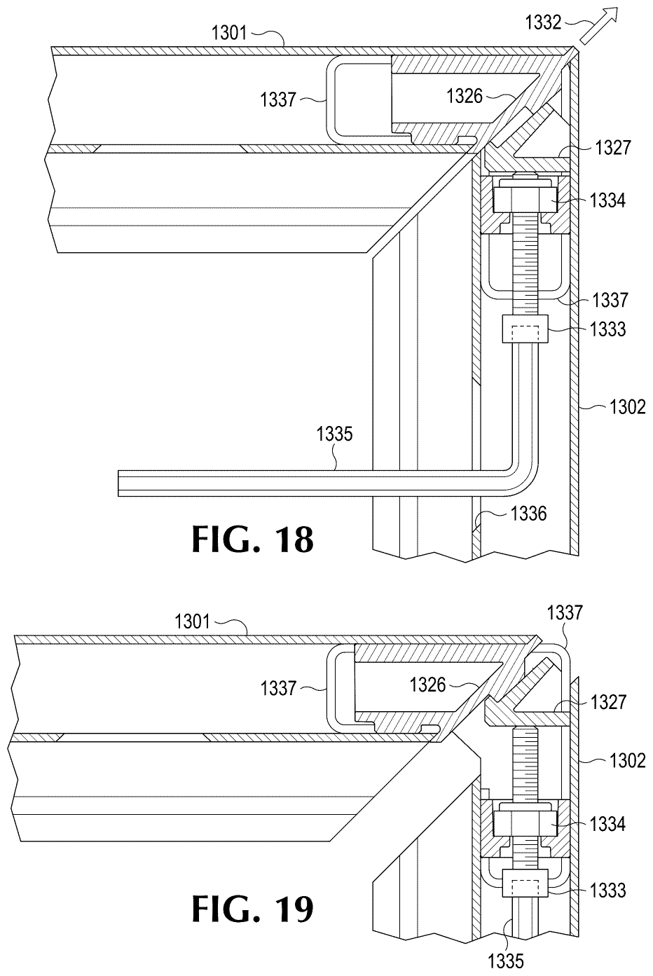

FIG. 15 is an exploded view of the tension-corner subassembly 1312 of FIG. 14. FIG. 16 is an isometric, sectional view of portions of an example tension-corner core 1325 to show further details, including how the adjustment nut 1334 is held in place by the tension-corner core 1325 in an example configuration. FIG. 17 is an isometric view of portions of the tension-corner subassembly 1312 of FIG. 14, showing an example engagement between an example first wedge 1326 and an example second wedge 1327. FIG. 18 is a sectional view of portions of an example corner of the window insert 1300 of FIG. 13, illustrating an example of a minimum-expansion state. FIG. 19 is a sectional view of portions of an example corner of the window insert 1300 of FIG. 13, illustrating an example of a maximum-expansion state.

As illustrated in FIGS. 15-19, the tension-corner subassembly 1312 includes a first wedge 1326, a second wedge 1327, and an adjustment mechanism 1328. The first wedge 1326 is snugly coupled, or fit closely, to the first framework 1301 and extends from the first end 1306 of the first framework 1301 toward the second end 1307 of the second framework 1302. In some configurations where the first framework 1301 has a central column 1313 that is substantially rectangular, the first wedge 1326 is pressed fit into the central column 1313 of the first framework 1301. The second wedge 1327 extends from the second end 1307 of the second framework 1302 toward the first end 1306 of the first framework 1301. An inclined surface 1329 of the second wedge 1327 is in sliding engagement with an inclined surface 1330 of the first wedge 1326. In configurations, the sliding engagement between the inclined surface 1329 of the second wedge 1327 and the inclined surface 1330 of the first wedge 1326 is via an interlocking fit 1331 between the inclined surface 1329 of the second wedge 1327 and the inclined surface 1330 of the first wedge 1326. As best shown in FIG. 17, the interlocking fit 1331 may be, for example, a dovetail connection.

The adjustment mechanism 1328 is configured to slide the second wedge 1327 relative to the second framework 1302 and relative to the inclined surface 1330 of the first wedge 1326 to move the corner from a minimum-expansion state—an example of which is shown in FIG. 18—to a maximum-expansion state—an example of which is shown in FIG. 19. From the point of reference of the first wedge 1326, the first wedge 1326 remains fixed in space, while the second wedge 1327 is pushed relative to the first wedge 1326 in the direction 1332 of the inclined surface 1330 of the first wedge 1326. In the illustrated configuration, the adjustment mechanism 1328 includes an adjustment screw 1333 that engages the second wedge 1327 and is threaded through an adjustment nut 1334. The adjustment nut 1334 is held in place by a tension-corner core 1325. The second wedge 1327 is slidingly coupled to and slides within the tension-corner core 1325. Consequently, the second wedge 1327 may extend from the second end 1307 of the second framework 1302 by a variable amount.

To adjust the corner, a tool, such as a hex wrench 1335 illustrated in FIG. 18, can be placed into an opening 1336 in the second framework 1302 and used to advance the adjustment screw 1333 into the threaded adjustment nut 1334, thereby pushing the second wedge 1327 toward the maximum-expansion state. (It is noted that a ball-end hex wrench would likely work better than the standard hex wrench drawn in FIG. 18, which is intended to illustrate the general concept of using a tool to adjust the corner.) Once the desired corner expansion is achieved (that is, between the minimum-expansion state and the maximum-expansion state, inclusive of those two endpoints), the hex wrench 1335 can be removed. In configurations, the adjustment mechanism 1328 is also configured to move the corner from the maximum-expansion state back to the minimum-expansion state by, for example, loosening the adjustment screw 1333.

In configurations, the tension-corner subassembly 1312 includes a frame 1337 coupling together the first wedge 1326, the second wedge 1327, the tension-corner core 1325, and the adjustment mechanism 1328 into a unified subassembly. The frame 1337 could be, for example, a spring wire. The frame 1337 provides structure to the unified subassembly, allowing the unified tension-corner subassembly 1312 to be installed as a unit into the corresponding frameworks 1305 as the components (the first wedge 1326, the second wedge 1327, the tension-corner core 1325, and the adjustment mechanism 1328) are already in their approximate positions relative to each other.

In configurations, aspects of the disclosed technology as described above may be provided in kit form. Accordingly, a kit for a window insert 1300 that is configured to provide secondary protection to an existing window may include four substantially rigid, elongated frameworks 1305 and four tension-corner subassemblies 1312. Each subassembly of the four tension-corner subassemblies 1312 includes an L-shaped frame 1337, a tension-corner core 1325, a first wedge 1326, a second wedge 1327, and an adjustment mechanism 1328.

The L-shaped frame 1337 has a first leg 1338 and a second leg 1339. As used in this disclosure, “L-shaped” means having the shape of a capital L, specifically two legs that are substantially perpendicular and extend from a common point, an example of which is shown in FIG. 15. The first wedge 1326 is secured to the first leg 1338 of the L-shaped frame 1337, and the tension-corner core 1325 is secured to the second leg 1339 of the L-shaped frame 1337. The second wedge 1327 is slidingly coupled to and within the tension-corner core 1325. The adjustment mechanism 1328 is coupled to the tension-corner core 1325 and configured to slide the second wedge 1327 relative to the tension-corner core 1325 and toward the first wedge 1326. The first leg 1338 of the L-shaped frame 1337 and the first wedge 1326 are configured to snugly fit within an end of each of the frameworks 1305. The second leg 1339 of the L-shaped frame 1337 and the tension-corner core 1325 are configured to snugly fit within an opposite end of each of the frameworks 1305. Accordingly, when assembled to form a window insert 1300, each L-shaped frame 1337 joins the end of one of the frameworks 1305 to the opposite end of another of the frameworks 1305.

As discussed above for other configurations, each framework 1305 of the kit may include a central column 1313 that is substantially rectangular. In such configurations, the first leg 1338 of the L-shaped frame 1337 and the first wedge 1326 are configured to snugly fit within the central column 1313 of the end of each of the frameworks 1305. Likewise, the second leg 1339 of the L-shaped frame 1337 and the tension-corner core 1325 are configured to snugly fit within the central column 1313 of the opposite end of each of the frameworks 1305.

The following installation description assumes a configuration as illustrated in FIGS. 13-20. Alterations can be made for configurations that contain additional or fewer components.

To install the window insert 1300 into the existing window frame 150, a tension-corner subassembly 1312 is installed at the desired corners by inserting the first leg 1338 of the L-shaped frame 1337 and the first wedge 1326 of the tension-corner subassembly 1312 into the first end 1306 of the desired framework(s) through the hole 1318 of the compressible seal 1317. For example, a tension-corner subassembly 1312 may be installed between the first framework 1301 and the second framework 1302 by inserting the first leg 1338 of the L-shaped frame 1337 and the first wedge 1326 of the tension-corner subassembly 1312 into the first end 1306 of the first framework 1301 through the hole 1318 of the compressible seal 1317. Similarly, a tension-corner subassembly 1312 may be installed between the third framework 1303 and the fourth framework 1304 by inserting the first leg 1338 of the L-shaped frame 1337 and the first wedge 1326 of the tension-corner subassembly 1312 into the first end 1306 of the third framework 1303 through the hole 1318 of the compressible seal 1317.

Next, the second leg 1339 of the L-shaped frame 1337 and the tension-corner core 1325 (containing the second wedge 1327) of the tension-corner subassembly 1312 is installed into the second end 1307 of the respective framework(s). For example, for a tension-corner subassembly 1312 installed between the first framework 1301 and the second framework 1302, the L-shaped frame 1337 and the tension-corner core 1325 (containing the second wedge 1327) of the tension-corner subassembly 1312 is installed into the second end 1307 of the second framework 1302. As another example, for a tension-corner subassembly 1312 installed between the third framework 1303 and the fourth framework 1304, the L-shaped frame 1337 and the tension-corner core 1325 (containing the second wedge 1327) of the tension-corner subassembly 1312 is installed into the second end 1307 of the fourth framework 1304.

For any corners not having the tension-corner subassembly 1312, an internal corner 425 (see FIG. 4) and a compressible seal 1317 may be placed between the ends of the respective frameworks 1305.

Next, from inside the building or room having the existing window frame 150, lift the window insert 1300 into the existing window frame 150 so that, starting from the top and working clockwise, the frameworks 1305 are in the following order: first framework 1301, second framework 1302, third framework 1303, and fourth framework 1304. Then, position the window insert 1300 at the desired distance from the glazing or other panel 1308 of the existing window frame 150. In configurations having bowed frameworks 1305, the midpoints 1314 of the frameworks 1305 will contact the existing window frame 150 until the corner is tightened with the adjustment screw 1333, as described next.

Next, one corner at a time, tighten the adjustment screw 1333 by way of a tool, such as the hex wrench 1335, inserted into the opening 1336 in the corresponding framework 1305 until the bumpers 1341 at the corresponding corner are compressed the desired amount. In the illustrated configuration, each framework 1305 has a bumper 1341 at its first end 1306 and at its second end 1307. Accordingly, when tightening the corner between the first framework 1301 and the second framework 1302, the bumpers 1341 that are on the first end 1306 of the first framework 1301 and the second end 1307 of the second framework 1302 are the bumpers 1341 at the corresponding corner. Preferably, the bumper 1341 is compressed from an uncompressed height of between about 0.140 inch and about 0.250 inch to a compressed height of approximately 0.125 inch, with a bulging surface of the bumper 1341 visible from the front of the assembled window insert 1300 (the front being the side having the cladding corners 1310). Then, if desired, caulk can be placed between the framework 1305 and the existing window frame 150.

Next, panel 1308, such as window glazing, is positioned within the window insert 1300 and against the glazing flanges 1319 of each of the frameworks 1305. Then, the cladding legs 1309 can be installed onto the cladding flanges 1323 of each of the frameworks 1305. Finally, the cladding corners 1310 are installed with screws or other fasteners (see, for example, the corner screws 422 and the screw caps 426 of FIG. 4), and the rear corner cover 1340 can be snapped in place (as shown for the rear corner cover 428 of FIG. 12).

Accordingly, installation of the window insert 1300 to an existing window frame 150 leaves the existing window frame intact, with little or no damage to the window frame 150.

Consequently, configurations of the disclosed technology allow components of a secondary window insert to adjust to the existing window itself upon installation. Such adjustment yields advantages over alternative systems, which may involve forcing a preassembled rectangular window insert into an existing window frame and unevenly absorbing out-of-squareness. As a result, configurations of the disclosed technology allow the use of rectangular glazing or panels in an existing window frame that is not square.

Furthermore, as discussed above, configurations of the disclosed technology allow parts to be manufactured and shipped individually—i.e., disassembled. As opposed to preassembling heavy window inserts and moving them while assembled, which may create greater risk of damage, components of the disclosed configurations may be moved in separate pieces and may be quickly assembled on site in the existing window frames. Moreover, because the frame components of the disclosed configurations may be structured to receive a wide variety of premanufactured panels, the components may be easily resized to fit a desired panel for a specific use without changing the way the components fit together and create an air seal with the existing window.

Additionally, configurations of the disclosed technology allows for thermal expansion of the window insert and the existing window frame, maintaining a nearly airtight seal after tens of thousands of hot-and-cold cycles.

Also, as configurations of the disclosed technology may include cladding, the cladding may dually serve to seal the internal frame and cover the internal frame with a desired aesthetic profile. In this way, the cladding may be customized to match the superficial and architectural features of a building, without changing the structure of the internal frame or the interfacing between the internal frame and the cladding.

### EXAMPLES

Illustrative examples of the disclosed technologies are provided below. A particular configuration of the technologies may include one or more, and any combination of, the examples described below.

Example 1 includes a window insert configured to provide secondary protection to an existing window, the window insert comprising: a substantially rigid first framework having a first end; a substantially rigid second framework having a first end, the first end of the second framework extending away from the first end of the first framework, the second framework being substantially perpendicular to the first framework; a first wedge snugly coupled to the first framework and extending from the first end of the first framework toward the first end of the second framework; a second wedge extending from the first end of the second framework toward the first end of the first framework, an inclined surface of the second wedge being in sliding engagement with an inclined surface of the first wedge; and an adjustment mechanism configured to slide the second wedge relative to the second framework and relative to the inclined surface of the first wedge.

Example 2 includes the window insert of Example 1, further comprising a frame coupling together the first wedge, the second wedge, and the adjustment mechanism into a unified subassembly.

Example 3 includes the window insert of any of Examples 1-2, in which the adjustment mechanism comprises an adjustment screw engaging the second wedge and threaded through an adjustment nut.

Example 4 includes the window insert of any of Examples 1-3, in which each of the first framework and the second framework comprise a central column that is substantially rectangular.

Example 5 includes the window insert of Example 4, in which the first wedge is pressed fit into the central column of the first framework.

Example 6 includes the window insert of any of Examples 1-5, in which each of the first framework and the second framework has a bow.

Example 7 includes the window insert of any of Examples 1-6, further comprising a compressible seal pinched between the first end of the first framework and the first end of the second framework.

Example 8 includes the window insert of any of Examples 1-7, in which the sliding engagement between the inclined surface of the second wedge and the inclined surface of the first wedge is via an interlocking fit between the inclined surface of the second wedge and the inclined surface of the first wedge.

Example 9 includes the window insert of any of Examples 1-8, in which the first framework has second end that is opposite the first end of the first framework, in which the second framework has second end that is opposite the first end of the second framework, the window insert further comprising a substantially rigid third framework having a first end and a second end opposite the first end of the third framework, the first end of the third framework extending away from the second end of the second framework, the third framework being substantially perpendicular to the second framework; and a substantially rigid fourth framework having a first end and a second end opposite the first end of the fourth framework, the second end of the fourth framework extending away from the second end of the third framework, the first end of the fourth framework extending away from the second end of the first framework, the fourth framework being substantially perpendicular to the third framework and to the first framework.

Example 10 includes a window insert configured to provide secondary protection to an existing window, the window insert comprising four spans, each span of the four spans comprising: a substantially rigid framework having a first end and a second end that is opposite the first end; a first wedge snugly coupled to the framework and extending from the first end of the framework; a second wedge extending from the second end by a variable amount; and an adjustment mechanism configured to slide the second wedge relative to the framework to increase the variable amount that the second wedge extends from the framework; in which a first span of the four spans is substantially perpendicular to a second span of the four spans, the second end of the framework of the second span extending away from the first end of the framework of the first span, an inclined surface of the second wedge of the second span being in sliding engagement with an inclined surface of the first wedge of the first span, the adjustment mechanism further configured to slide the second wedge of the second span relative to the inclined surface of the first wedge of the first span; in which the second span is substantially perpendicular to a third span of the four spans, the second end of the framework of the third span extending away from the first end of the framework of the second span, an inclined surface of the second wedge of the third span being in sliding engagement with an inclined surface of the first wedge of the second span, the adjustment mechanism further configured to slide the second wedge of the third span relative to the inclined surface of the first wedge of the second span; in which the third span is substantially perpendicular to a fourth span of the four spans, the second end of the framework of the fourth span extending away from the first end of the framework of the third span, an inclined surface of the second wedge of the fourth span being in sliding engagement with an inclined surface of the first wedge of the third span, the adjustment mechanism further configured to slide the second wedge of the fourth span relative to the inclined surface of the first wedge of the third span; and in which the fourth span further is substantially perpendicular to the first span, the second end of the framework of the first span extending away from the first end of the framework of the fourth span, an inclined surface of the second wedge of the first span being in sliding engagement with an inclined surface of the first wedge of the fourth span, the adjustment mechanism further configured to slide the second wedge of the first span relative to the inclined surface of the first wedge of the fourth span.

Example 11 includes the window insert of Example 10, in which the framework has a central column that is substantially rectangular.

Example 12 includes the window insert of Example 11, further comprising a glazing flange extending away from a first edge of the central column in a transverse direction of the central column, the transverse direction being substantially perpendicular to a longitudinal direction of the central column, the glazing flange configured to align a window panel to the framework.

Example 13 includes the window insert of Example 12, further comprising a window panel that overlaps the glazing flange of each span of the four spans of the window insert.

Example 14 includes the window insert of Example 13, further comprising a datum, one side of the central column coinciding with the datum, and a cladding flange, the cladding flange extending away from the datum in the transverse direction of the central column, the datum being substantially perpendicular to the transverse direction of the central column, the cladding flange configured to align window cladding to the framework.

Example 15 includes the window insert of Example 14, further comprising a panel gasket coupled to the glazing flange and extending toward the cladding flange, the window panel contacting the panel gasket.

Example 16 includes the window insert of any of Examples 4-15, further comprising an auxiliary gasket coupled to the cladding flange and extending toward the glazing flange.

Example 17 includes the window insert of any of Examples 14-16, further comprising window cladding contacting the cladding flange of each span of the four spans of the window insert.

Example 18 includes the window insert of Example 17, in which each of the window cladding has an outward bow.

Example 19 includes a kit for a window insert that is configured to provide secondary protection to an existing window, the kit comprising: four substantially rigid, elongated frameworks; and four tension-corner subassemblies, each subassembly of the four tension-corner subassemblies comprising: an L-shaped frame having a first leg and a second leg, a tension-corner core secured to the second leg of the L-shaped frame, a first wedge secured to the first leg of the L-shaped frame, a second wedge slidingly coupled to and within the tension-corner core, and an adjustment mechanism coupled to the tension-corner core and configured to slide the second wedge relative to the tension-corner core and toward the first wedge; in which the first leg of the L-shaped frame and the first wedge are configured to snugly fit within an end of each of the frameworks, in which the second leg of the L-shaped frame and the tension-corner core are configured to snugly fit within an opposite end of each of the frameworks, such that, when assembled to form a window insert, each L-shaped frame joins the end of one of the frameworks to the opposite end of another of the frameworks.

Example 20 includes the kit of Example 19, in which the adjustment mechanism comprises an adjustment screw engaging the second wedge and threaded through an adjustment nut, the adjustment nut being secured within the tension-corner core.

Example 21 includes the kit of any of Examples 19-20, in which each framework includes a central column that is substantially rectangular, in which the first leg of the L-shaped frame and the first wedge are configured to snugly fit within the central column of the end of each of the frameworks, in which the second leg of the L-shaped frame and the tension-corner core are configured to snugly fit within the central column of the opposite end of each of the frameworks.

Example 22 includes the kit of any of Examples 19-21, further comprising four compressible seals, each configured to, when assembled to form a window insert, be pinched between the end of one of the frameworks and the opposite end of another of the frameworks.

Example 23 includes a window insert configured to provide secondary protection to an existing window, the window insert comprising: a substantially rigid first framework having a first end; a substantially rigid second framework having a first end, the first end of the second framework extending away from the first end of the first framework, the second framework being substantially perpendicular to the first framework; an internal corner that is substantially L-shaped, a first portion of the internal corner configured to fit into the first end of the first framework and a second portion of the internal corner configured to fit into the first end of the second framework; and a compressible seal pinched between the first end of the first framework and the first end of the second framework.

Example 24 includes the window insert of Example 23, in which the compressible seal is a foam seal.

Example 25 includes the window insert of Example 23, in which the compressible seal is a closed-cell foam seal.

Example 26 includes the window insert of any of Examples 23-25, in which the internal corner passes through a hole in the compressible seal when the internal corner is assembled together with the compressible seal, the first framework, and the second framework.

Example 27 includes a window insert configured to provide secondary protection to an existing window, the window insert comprising four spans, each span of the four spans including a substantially rigid framework, each substantially rigid framework having a datum that is substantially perpendicular to a transverse direction of framework and to a longitudinal direction of the framework, the transverse direction being substantially perpendicular to the longitudinal direction of the framework; a glazing flange extending away from the datum in the transverse direction of the framework, the glazing flange configured to align a window panel to the framework; a cladding flange extending away from the datum in the transverse direction of the framework, the cladding flange configured to align window cladding to the framework; in which a first span of the four spans is substantially perpendicular to a second span of the four spans; in which the second span is substantially perpendicular to a third span of the four spans; in which the third span is substantially perpendicular to a fourth span of the four spans; and in which the fourth span further is substantially perpendicular to the first span.

Example 28 includes the window insert of Example 27, further comprising an auxiliary gasket coupled to the cladding flange and extending toward the glazing flange.

Example 29 includes the window insert of any of Examples 27-28, further comprising a panel gasket coupled to the glazing flange and extending toward the cladding flange.

Example 30 includes the window insert of any of Examples 27-29, further comprising a window panel overlapping the glazing flange of each span of the four spans of the window insert and a cladding leg contacting the cladding flange of each span of the four spans of the window insert, one cladding leg per span, the cladding leg securing the window panel between the cladding leg and the glazing flange.

Example 31 includes a window insert configured to provide secondary protection to an existing window, the window insert comprising: a substantially rigid first framework having a first end; a substantially rigid second framework having a first end, the first end of the second framework extending away from the first end of the first framework, the second framework being substantially perpendicular to the first framework; an internal corner that is substantially L-shaped, a first portion of the internal corner configured to fit into the first end of the first framework and a second portion of the internal corner configured to fit into the first end of the second framework, at least one of the first portion of the internal corner or the second portion of the internal corner having a friction nub on an outer surface of the internal corner, the friction nub configured to contact an internal surface of the respective first framework or second framework, allowing a loose fit between the internal corner (except for the friction nub) and the respective first framework or second framework.

Example 32 includes the window insert of Example 31, the friction nub comprising raised surfaces midway along the respective first portion or the second portion.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I (or we) claim:

1. A window insert configured to provide secondary protection to an existing window, the window insert comprising:
a substantially rigid first framework having a first end;
a substantially rigid second framework having a first end, the first end of the second framework extending away from the first end of the first framework, the second framework being substantially perpendicular to the first framework;
a first wedge snugly coupled to the first framework and extending from the first end of the first framework toward the first end of the second framework;
a second wedge extending from the first end of the second framework toward the first end of the first framework, an inclined surface of the second wedge being in sliding engagement with an inclined surface of the first wedge; and
an adjustment mechanism configured to slide the second wedge relative to the second framework and relative to the inclined surface of the first wedge.

2. The window insert of claim 1, further comprising a frame coupling together the first wedge, the second wedge, and the adjustment mechanism into a unified subassembly.

3. The window insert of claim 1, in which the adjustment mechanism comprises an adjustment screw engaging the second wedge and threaded through an adjustment nut.

4. The window insert of claim 1, in which each of the first framework and the second framework comprise a central column that is substantially rectangular.

5. The window insert of claim 4, in which the first wedge is pressed fit into the central column of the first framework.

6. The window insert of claim 1, in which each of the first framework and the second framework has a bow.

7. The window insert of claim 1, further comprising a compressible seal pinched between the first end of the first framework and the first end of the second framework.

8. The window insert of claim 1, in which the sliding engagement between the inclined surface of the second wedge and the inclined surface of the first wedge is via an interlocking fit between the inclined surface of the second wedge and the inclined surface of the first wedge.

9. The window insert of claim 1, in which the first framework has second end that is opposite the first end of the first framework, in which the second framework has second end that is opposite the first end of the second framework, the window insert further comprising:
a substantially rigid third framework having a first end and a second end opposite the first end of the third framework, the first end of the third framework extending away from the second end of the second framework, the third framework being substantially perpendicular to the second framework; and
a substantially rigid fourth framework having a first end and a second end opposite the first end of the fourth framework, the second end of the fourth framework extending away from the second end of the third framework, the first end of the fourth framework extending away from the second end of the first framework, the fourth framework being substantially perpendicular to the third framework and to the first framework.

10. A window insert configured to provide secondary protection to an existing window, the window insert comprising four spans, each span of the four spans comprising:
a substantially rigid framework having a first end and a second end that is opposite the first end;
a first wedge snugly coupled to the framework and extending from the first end of the framework;
a second wedge extending from the second end by a variable amount; and
an adjustment mechanism configured to slide the second wedge relative to the framework to increase the variable amount that the second wedge extends from the framework;
in which a first span of the four spans is substantially perpendicular to a second span of the four spans, the second end of the framework of the second span extending away from the first end of the framework of the first span, an inclined surface of the second wedge of the second span being in sliding engagement with an inclined surface of the first wedge of the first span, the adjustment mechanism further configured to slide the second wedge of the second span relative to the inclined surface of the first wedge of the first span;
in which the second span is substantially perpendicular to a third span of the four spans, the second end of the framework of the third span extending away from the first end of the framework of the second span, an inclined surface of the second wedge of the third span being in sliding engagement with an inclined surface of the first wedge of the second span, the adjustment mechanism further configured to slide the second wedge of the third span relative to the inclined surface of the first wedge of the second span;
in which the third span is substantially perpendicular to a fourth span of the four spans, the second end of the framework of the fourth span extending away from the first end of the framework of the third span, an inclined surface of the second wedge of the fourth span being in sliding engagement with an inclined surface of the first wedge of the third span, the adjustment mechanism further configured to slide the second wedge of the fourth span relative to the inclined surface of the first wedge of the third span; and
in which the fourth span further is substantially perpendicular to the first span, the second end of the framework of the first span extending away from the first end of the framework of the fourth span, an inclined surface of the second wedge of the first span being in sliding engagement with an inclined surface of the first wedge of the fourth span, the adjustment mechanism further configured to slide the second wedge of the first span relative to the inclined surface of the first wedge of the fourth span.

11. The window insert of claim 10, in which the framework has a central column that is substantially rectangular.

12. The window insert of claim 11, further comprising a glazing flange extending away from a first edge of the central column in a transverse direction of the central column, the transverse direction being substantially perpendicular to a longitudinal direction of the central column, the glazing flange configured to align a window panel to the framework.

13. The window insert of claim 12, further comprising a window panel that overlaps the glazing flange of each span of the four spans of the window insert.

14. The window insert of claim 13, further comprising a datum, one side of the central column coinciding with the datum, and a cladding flange, the cladding flange extending away from the datum in the transverse direction of the central column, the datum being substantially perpendicular to the transverse direction of the central column, the cladding flange configured to align window cladding to the framework.

15. The window insert of claim 14, further comprising a panel gasket coupled to the glazing flange and extending toward the cladding flange, the window panel contacting the panel gasket.

16. The window insert of claim 14, further comprising an auxiliary gasket coupled to the cladding flange and extending toward the glazing flange.

17. The window insert of claim 14, further comprising window cladding contacting the cladding flange of each span of the four spans of the window insert.

18. The window insert of claim 17, in which each of the window cladding has an outward bow.

19. A kit for a window insert that is configured to provide secondary protection to an existing window, the kit comprising:
four substantially rigid, elongated frameworks; and
four tension-corner subassemblies, each subassembly of the four tension-corner subassemblies comprising:
an L-shaped frame having a first leg and a second leg,
a tension-corner core secured to the second leg of the L-shaped frame,
a first wedge secured to the first leg of the L-shaped frame,
a second wedge slidingly coupled to and within the tension-corner core, and
an adjustment mechanism coupled to the tension-corner core and configured to slide the second wedge relative to the tension-corner core and toward the first wedge;
in which the first leg of the L-shaped frame and the first wedge are configured to snugly fit within an end of each of the frameworks, in which the second leg of the L-shaped frame and the tension-corner core are configured to snugly fit within an opposite end of each of the frameworks, such that, when assembled to form a window insert, each L-shaped frame joins the end of one of the frameworks to the opposite end of another of the frameworks.

20. The kit of claim 19, in which the adjustment mechanism comprises an adjustment screw engaging the second wedge and threaded through an adjustment nut, the adjustment nut being secured within the tension-corner core.

21. The kit of claim 19, in which each framework includes a central column that is substantially rectangular, in which the first leg of the L-shaped frame and the first wedge are configured to snugly fit within the central column of the end of each of the frameworks, in which the second leg of the L-shaped frame and the tension-corner core are configured to snugly fit within the central column of the opposite end of each of the frameworks.

22. The kit of claim 19, further comprising four compressible seals, each configured to, when assembled to form a window insert, be pinched between the end of one of the frameworks and the opposite end of another of the frameworks.

23. A window insert configured to provide secondary protection to an existing window, the window insert comprising:
a substantially rigid first framework having a first end;
a substantially rigid second framework having a first end, the first end of the second framework extending away from the first end of the first framework, the second framework being substantially perpendicular to the first framework;
an internal corner that is substantially L-shaped, a first portion of the internal corner configured to fit into the first end of the first framework and a second portion of the internal corner configured to fit into the first end of the second framework; and
a compressible seal pinched between the first end of the first framework and the first end of the second framework.

24. The window insert of claim 23, in which the compressible seal is a foam seal.

25. The window insert of claim 23, in which the compressible seal is a closed-cell foam seal.

26. The window insert of claim 23, in which the internal corner passes through a hole in the compressible seal when the internal corner is assembled together with the compressible seal, the first framework, and the second framework.

27. A window insert configured to provide secondary protection to an existing window, the window insert comprising four spans, each span of the four spans including a substantially rigid framework, each substantially rigid framework having:
a datum that is substantially perpendicular to a transverse direction of framework and to a longitudinal direction of the framework, the transverse direction being substantially perpendicular to the longitudinal direction of the framework;
a glazing flange extending away from the datum in the transverse direction of the framework, the glazing flange configured to align a window panel to the framework;
a cladding flange extending away from the datum in the transverse direction of the framework, the cladding flange configured to align window cladding to the framework;
in which a first span of the four spans is substantially perpendicular to a second span of the four spans; in which the second span is substantially perpendicular to a third span of the four spans; in which the third span is substantially perpendicular to a fourth span of the four spans; and in which the fourth span further is substantially perpendicular to the first span.

28. The window insert of claim 27, further comprising an auxiliary gasket coupled to the cladding flange and extending toward the glazing flange.

29. The window insert of claim 27, further comprising a panel gasket coupled to the glazing flange and extending toward the cladding flange.

30. The window insert of claim 27, further comprising a window panel overlapping the glazing flange of each span of the four spans of the window insert and a cladding leg contacting the cladding flange of each span of the four spans of the window insert, one cladding leg per span, the cladding leg securing the window panel between the cladding leg and the glazing flange.

31. A window insert configured to provide secondary protection to an existing window, the window insert comprising:
a substantially rigid first framework having a first end;
a substantially rigid second framework having a first end, the first end of the second framework extending away from the first end of the first framework, the second framework being substantially perpendicular to the first framework;
an internal corner that is substantially L-shaped, a first portion of the internal corner configured to fit into the first end of the first framework and a second portion of the internal corner configured to fit into the first end of the second framework, at least one of the first portion of the internal corner or the second portion of the internal corner having a friction nub on an outer surface of the internal corner, the friction nub configured to contact an internal surface of the respective first framework or second framework, allowing a loose fit between the internal corner (except for the friction nub) and the respective first framework or second framework.

32. The window insert of claim 31, the friction nub comprising raised surfaces midway along the respective first portion or the second portion.
